(19) United States
(12) Patent Application Publication
(10) Pub. No.: US 2018/0356881 A1
(43) Pub. Date: Dec. 13, 2018

(54) Pairing of wireless earpiece to phone or other device

(71) Applicant: BRAGI GmbH, Munchen (DE)

(72) Inventor: Luigi Belverato, München (DE)

(73) Assignee: BRAGI GmbH, München (DE)

(21) Appl. No.: 15/975,345

(22) Filed: May 9, 2018

Related U.S. Application Data
(60) Provisional application No. 62/516,163, filed on Jun. 7, 2017.

(51) Int. Cl. G06F 3/01; G06F 3/044; G06F 3/0487; H04M 1/60

(52) U.S. Cl. CPC G06F 3/012; G06F 3/044; G06F 3/017; H04M 1/6066; G06F 3/0487

(57) ABSTRACT

A wireless earpiece in embodiments of the present invention may have one or more of the following features: (a) an earpiece housing, (b) a processor disposed within the earpiece housing, (c) a motion sensor operatively connected to the processor, (d) a gesture interface operatively connected to the processor, (e) a wireless transceiver operatively connected to the processor wherein the wireless earpiece is configured to operably connect to an electronic device via the wireless transceiver in response to a user gesture sensed by the motion sensor or the gesture interface, and (f) one or more speakers operatively connected to the processor, wherein an audio prompt is played to the user through the one or more speakers for the user to provide the user gesture to connect to the electronic device.

### PRIORITY STATEMENT

This application claims priority to U.S. Provisional Patent Application No. 62/516,163 filed on Jun. 7, 2017 titled Pairing of Wireless Earpiece to Phone or Other Device all of which are hereby incorporated by reference in their entireties.

### FIELD OF THE INVENTION

The illustrative embodiments relate to wearable devices. Particularly, the illustrative embodiments relate to wireless earpieces. More particularly, but not exclusively, the illustrative embodiments relate to the pairing of wireless earpieces to other devices.

### BACKGROUND

Wireless earpieces are a new category of consumer electronic device. Wireless earpieces allow the user to listen to songs, news, or other types of media with or without the need to be directly connected to another electronic device. In some cases, connecting to, pairing with, or otherwise communicating with electronic devices may require extensive feedback and user input.

Recent advances in technology have resulted in a proliferation of computers, electronic devices and associated accessories and peripherals adapted to link up with and communicate with each other. While many links and communications between such devices and accessories take place over wired connections, such links and communications between devices are increasingly taking place wirelessly. Examples of “host” devices for such wireless communications can include personal computers, cellular telephones, laptops, tablet computers and the like, while examples of “accessory” or peripheral devices can include headphones, wireless earpieces, keyboards, mice, printers, various other human interface (“HI”) devices and the like. The ability for such devices to communicate wirelessly presents numerous advantages and conveniences to users and consumers. Increases in the amount of wireless communications between devices in the future are inevitable.

One process ubiquitous in such wireless communications arrangements is the bonding or pairing of devices. Pairing is a process used to associate a wireless accessory or peripheral device with a wireless host device. The pairing ensures the data being transferred is not only secured but is also being transferred between appropriate devices. For example, a pairing can be used to associate a given headset or earpiece with a particular mobile phone, and vice versa. Another example can include the pairing of a wireless keyboard and wireless mouse to a computer or other host device. The pairing provides for secure data transfer between the devices, typically through use of encryption.

Although pairing can sometimes require a pin code or other identifier be entered manually by a user to pair a host device with an accessory device, many pairings between devices now use more streamlined processes, such as the Secure Simple Pairing protocol required by Bluetooth v2.1 and later devices. Such cases can involve “just works” type of devices, such as earpieces for cellular telephones or wireless mice and keyboards for computers, among others. In other circumstances, it is possible a user need not enter a pin code or take other action because a proprietary exchange of information can also facilitate pairing. In such instances, it is often sufficient for a wireless accessory device simply to enter a range of a wireless host to which it can be paired. Such streamlined processes result in a more convenient and user-friendly experience for many users and consumers.

In many such simplified cases, a wireless accessory device not paired with a host device is put into a “search” mode, whereby it actively searches for a host device with which to pair. The pairing process is then typically triggered automatically the first time the accessory device comes into range of, finds and requests to pair with a suitable host device. During the pairing process, the two devices involved establish a relationship by creating a shared secret or link key. Once a unique link key is stored by both devices, they then become paired. A device wanting to communicate only with a paired device can cryptographically authenticate the identity of the other device to be sure it is the same device with which it has previously paired. Once a link key has been generated, an authenticated link between the devices may be encrypted so the data they exchange over the airwaves is protected against eavesdropping or other unauthorized communications.

Once a pairing has been established it is remembered by the devices, which then connect to each without further user intervention. In fact, a pairing of wireless devices often remains for significant periods of time, even indefinitely. When desired, the pairing relationship can later be terminated manually by the user. In addition, the removal of one of the devices from the wireless range of the other can also facilitate the termination of a pairing relationship. In such instances, link keys can be deleted at any time by either device. If done by either device this will implicitly remove the pairing between the devices.

Unfortunately, the facilitation of pairing between wireless devices has become so streamlined the unpairing of paired devices can be troublesome in some cases. This often occurs where an accessory device is a simplified device with no display or readily understandable process for unpairing. In such instances, transferring a pairing to another host device or any other unpairing of the accessory device from its currently paired host can require separating the devices until they are out of range with each other for some time, so the simpler accessory device eventually goes into search mode again for another host device. Other inconvenient solutions to invoke a changed pairing of a wireless accessory device can include turning off one or more devices or excessive manual intervention into the unpairing and reassigning of a new pairing for the accessory device.

While many designs and techniques used to provide pairings between wireless host and accessory devices have generally worked well in the past, there is always a desire to provide improvements in such wireless systems and pairing methods. What is desired are systems and methods permitting the easy transfer of pairings from one wireless host device to another, as well as permit the ready selection of a wireless host device from multiple present and possible host devices for a wireless accessory device.

### SUMMARY

Therefore, it is a primary object, feature, or advantage of the illustrative embodiments to improve over the state of the art.

A wireless earpiece in embodiments of the present invention may have one or more of the following features: (a) an earpiece housing, (b) a processor disposed within the earpiece housing, (c) a motion sensor operatively connected to the processor, (d) a gesture interface operatively connected to the processor, (e) a wireless transceiver operatively connected to the processor wherein the wireless earpiece is configured to operably connect to an electronic device via the wireless transceiver in response to a user gesture sensed by the motion sensor or the gesture interface, and (f) one or more speakers operatively connected to the processor, wherein an audio prompt is played to the user through the one or more speakers for the user to provide the user gesture to connect to the electronic device.

A set of wireless earpieces, each wireless earpiece in embodiments of the present invention may have one or more of the following features: (a) an earpiece housing, (b) a processor disposed within each earpiece housing, (c) a motion sensor disposed within each earpiece housing and operatively connected to the processor, (d) a gesture interface disposed within each earpiece housing and operatively connected to the processor in the earpiece housing in which the gesture interface is mounted to, and (e) a wireless transceiver disposed within each earpiece housing and operatively connected to the processor in the earpiece housing in which the wireless transceiver is disposed within wherein at least one wireless earpiece of the set of wireless earpieces receives a selection by a first user gesture sensed by the motion sensor or the gesture interface to search for electronic devices available for connection and wherein at least one wireless earpiece of the set of wireless earpieces operably connects to one or more of the electronic devices via the wireless transceiver of the at least one wireless earpiece in response to a second user gesture sensed by the motion sensor of the at least one wireless earpiece or the gesture interface of the at least one earpiece.

A method of connecting a wireless earpiece to an electronic device in embodiments of the present invention may have one or more of the following steps: (a) sensing a gesture from a user at the wireless earpiece, (b) prompting the user to connect to the electronic device, (c) connecting the wireless earpiece to the electronic device in response to the gesture from the user, and (d) sensing audio input including a verbal name or description associated with the electronic device for utilization with the gesture to connect to the electronic device.

One or more of these and/or other objects, features, or advantages of the illustrative embodiments will become apparent from the specification and following claims. No single embodiment need provide every object, feature, or advantage. Different embodiments may have different objects, features, or advantages. Therefore, the illustrative embodiments are not to be limited to or by any object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 illustrates a block diagram of the earpiece in accordance with an embodiment of the present invention;

FIG. 2 illustrates a block diagram of another embodiment of the earpiece in accordance with an embodiment of the present invention;

FIG. 3 illustrates a set of wireless earpieces in accordance with an embodiment of the present invention;

FIG. 4 illustrates a right wireless earpiece and its relationship to the ear anatomy of a user in accordance with an embodiment of the present invention;

FIG. 5 illustrates the set of wireless earpieces and their relationship to a mobile device in accordance with an embodiment of the present invention;

FIG. 6 illustrates a flowchart of a method of connecting a wireless earpiece to an electronic device in accordance with an embodiment of the present invention; and

FIG. 7 illustrates a flowchart of a second embodiment of a method of connecting a wireless earpiece to an electronic device in accordance with an embodiment of the present invention.

Various of the figures include ornamental appearance for various elements. It is to be understood the illustrative embodiments contemplate all permutations and combinations of the various graphical elements set forth.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of wireless earpieces with gestural pairing control, it is fully contemplated embodiments of the present invention could be used in most any wearable electronic device without departing from the spirit of the invention.

The illustrative embodiments provide a system, method and wireless earpieces for easily pairing or communicating with electronic devices. For example, using gestures or input, such as nodding or tapping to connect to other electronic devices. Any number of systems, methods, and processes utilized by the wireless earpieces may be utilized to connect to electronic devices.

It is an object, feature, or advantage of the illustrative embodiments to connect or pair one or more wireless earpieces to an electronic device.

It is a still further object, feature, or advantage of the illustrative embodiments to connect or pair one or more wireless earpieces to an electronic device using a gesture.

Another object, feature, or advantage is to connect or pair one or more wireless earpieces to an electronic device using a head gesture sensed by a motion sensor associated with an earpiece.

Yet another object, feature, or advantage is to connect or pair one or more wireless earpieces to an electronic device using a gesture sensed by a gesture interface.

Yet another object, feature, or advantage is to connect or pair an electronic device to one or more wireless earpieces using a gesture to initiate a connection request to the electronic device wherein the electronic device accepts the connection request.

In one embodiment, a wireless earpiece includes an earpiece housing, a processor disposed within the earpiece housing, a motion sensor operatively connected to the earpiece housing and the processor, a gestural interface operatively connected to the earpiece housing and the processor, and a wireless transceiver operatively connected to the earpiece housing and the processor. The wireless earpiece is configured to operably connect to an electronic device via the wireless transceiver in response to a user gesture sensed by the motion sensor or the gesture interface.

One or more of the following features may be included. The motion sensor may be an electronic accelerometer. The gesture interface may further comprise an emitter and a detector. The user gesture may be a nod. The user gesture may be a tap on the gesture interface. The user gesture may be a motion sensed by the detector. The electronic device may be a mobile phone. The electronic device may be a tablet. The electronic device may be a laptop.

In another embodiment, a set of wireless earpieces includes an earpiece housing, a processor disposed within each earpiece housing, a motion sensor mounted to each earpiece housing and operatively connected to the processor in the earpiece housing in which the motion sensor is mounted to, a gesture interface mounted to each earpiece housing and operatively connected to the processor in the earpiece housing in which the gesture interface is mounted to, and a wireless transceiver disposed within each earpiece housing and operatively connected to the processor in the earpiece housing in which the wireless transceiver is disposed within. At least one wireless earpiece of the set of wireless earpieces operably connects to an electronic device via the wireless transceiver of the at least one wireless earpiece in response to a user gesture sensed by the motion sensor of the at least one wireless earpiece or the gesture interface of the at least one earpiece.

One or more of the following features may be included. The set of wireless earpieces may comprise a left wireless earpiece and a right earpiece. The user gesture may be a nod sensed by the motion sensor. The user gesture may be a tap on the gesture interface.

In another embodiment, a method of connecting a wireless earpiece to an electronic device includes sensing a gesture from a user at the wireless earpiece and connecting the wireless earpiece to the electronic device in response to the gesture from the user.

One or more of the following features may be included. The gesture may be sensed by a motion sensor operatively connected to the earpiece. The gesture may be a nod. The gesture may be sensed by a gesture interface operatively connected to the earpiece. The gesture may be a tap on the gesture interface. The electronic device may be a mobile phone. The user may be prompted to connect to the electronic device.

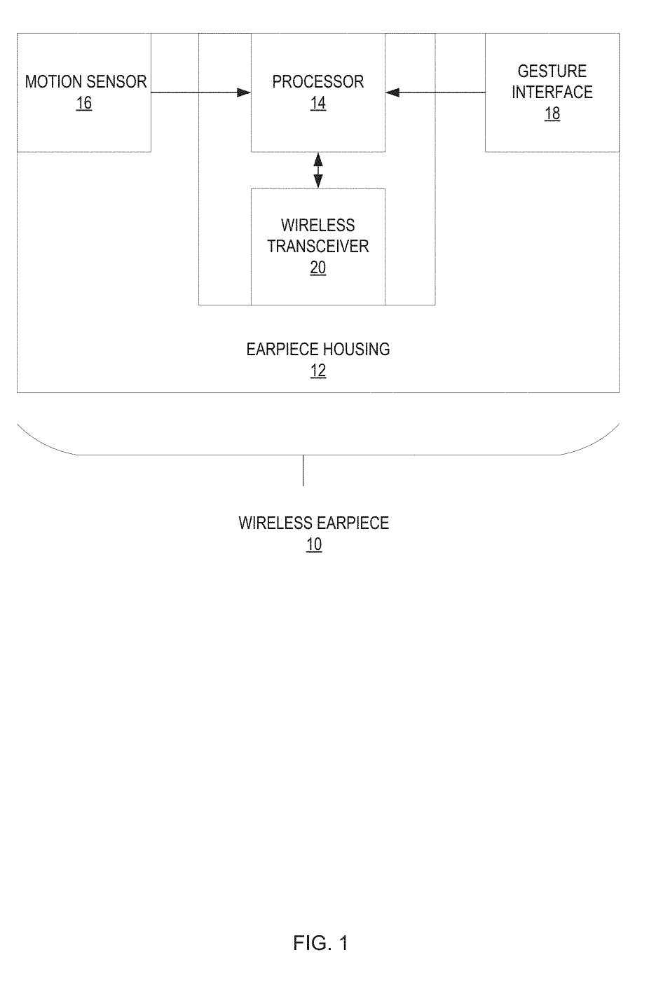

FIG. 1 illustrates a block diagram of a wireless earpiece 10. The wireless earpiece 10 may include an earpiece housing 12, a processor 14 disposed within the earpiece housing 12, a motion sensor 16 operatively connected to the processor 14, and a gesture interface 18 operatively connected to the processor 14. Both the motion sensor 16 and the gesture interface 18 are configured to sense gestures from the user. One or more sleeves may be provided with the wireless earpiece 10 fitted over a portion of the earpiece housing 12. The sleeves may come in various shapes and sizes and may be used to improve the fit of the wireless earpiece 10 within an ear of the user, improve audio transparency (allow through all or portions of environmental sounds and noises), improve the longevity of the wireless earpiece 10, protect the user from skin allergies, and so forth.

The earpiece housing 12 is a structure shaped to fit substantially within an ear of the user. The earpiece housing 12 may at least partially enclose one or more of the components of the wireless earpiece 10 and may be composed of one or more plastics, one or more metals, one or more polymers, one or more non-metals, or any material or combination of materials having substantial deformation resistance to facilitate energy transfer if a sudden force is applied to the wireless earpiece 10. For example, if the wireless earpiece 10 is dropped by the user, the earpiece housing 12 may transfer the energy received from the surface impact throughout the entire wireless earpiece 10 thereby minimizing damage.

In addition, the earpiece housing 12 may be capable of a degree of flexibility to facilitate energy absorbance if one or more forces is applied to the wireless earpiece 10. For example, if an object is dropped on the wireless earpiece 10, the earpiece housing 12 may bend to absorb the energy from the impact. The flexibility of the earpiece housing 12 should not, however, be flexible to the point where one or more components of the wireless earpiece 10 may become dislodged or otherwise rendered non-functional due to the force of the impact. The earpiece housing 12 may also be waterproof, enclosing components within the wireless earpiece 10.

The processor 14 is disposed within, mounted to, or integrated with the earpiece housing 12 and is operatively connected to each of the components of the wireless earpiece 10. The processor 14 may be a digital integrated circuit, an analog integrated circuit, a mixed integrated circuit, an application-specific integrated circuit, an intelligent control unit, a central processing unit, or another type of component capable of processing data and/or information, and more than one of the types of processors integrated together. The processor 14 may include a register with data and/or instructions stored thereon for controlling the wireless earpiece 10. The processor 14 may also include logic circuitry, which may consist of combinational and/or sequential digital logic, for controlling one or more functions of the wireless earpiece 10. In addition, data and/or information stored in one or more cache memories within the processor 14 may be used by the logic circuitry to enhance the functionality of the wireless earpiece 10.

Furthermore, processor 14 may be programmed to execute one or more kernels, operating systems, modules, applications, programs, and/or instructions to control the wireless earpiece 10 or process information received from one or more of the components of the wireless earpiece 10. The kernels, applications, programs, and/or instructions used by the processor 14 may be stored in one or more memories, the register, or one or more cache memories within the processor 14 and may be used to control one or more functions of the wireless earpiece 10. For example, the processor 14 may process a request in the form of a gesture from the user to connect the wireless earpiece 10 to the user's smartphone. The processor 14 may subsequently execute instructions to a wireless or Bluetooth transceiver to search for one or more signals encoding one or more connection frequencies transmitted by the smartphone. Alternatively, the processor 14 may execute instructions to the wireless or Bluetooth transceiver to transmit signals encoding one or more frequencies in which to connect to the wireless earpiece 10. The signals transmitted by the wireless earpiece 10 or smartphone may be signals transmitted under an 802.11ac, 802.11x, or another similar wireless standard. If the other device receives the signal encoding a frequency in which to connect, the wireless earpiece 10 and/or smartphone may connect automatically or prompt a party, which may be the user or one or more third parties, whether the party wants to connect.

A motion sensor 16 is operatively connected to the processor 14 and may be mounted to or integrated with the earpiece housing 12. The motion sensor 16 senses motions from a user's head and neck area and may include any type of sensor capable of sensing head motion. For example, the sensor 16 may be an electronic accelerometer, which may be piezoelectric, piezoresistive, or capacitive, configured to sense the nodding or shaking of the user's head. Sensor readings from the electronic accelerometer are communicated to the processor 14, which may use the readings when executing a program to connect the wireless earpiece 10 to another electronic device. In addition, the processor 14 may store the readings in a memory for later use.

A gesture interface 18 is operatively connected to the processor 14 and may be mounted to or integrated with the earpiece housing 12 and may be configured to allow a user to control one or more programs or functions of the wireless earpiece 10. In one embodiment, the gesture interface 18 may include at least one emitter 36 and at least one detector 38 to detect gestures from either the user, a third-party, an instrument, or a combination and communicate one or more signals representing the gesture to the processor 14. For example, the gesture interface 18 may represent an infrared sensor, a capacitive/touch sensor, proximity sensors, or so forth. The gestures used with the gesture interface 18 to control the wireless earpiece 10 include, without limitation, touching, tapping, swiping, use of an instrument, or any combination of the gestures. Touching gestures used to control the wireless earpiece 10 may be of any duration and may include the touching of areas not part of the gesture interface 18. Tapping gestures used to control the wireless earpiece 10 may include any number of taps and need not be brief. Swiping gestures used to control the wireless earpiece 10 may include a single swipe, a swipe changing direction at least once, a swipe with a time delay, a plurality of swipes, or any combination. The gestures may represent physical contact with the gesture interface 18 or hand shapes, messages, or gestures made proximate the gesture interface 18. An instrument used to control the wireless earpiece 10 may be electronic, biochemical or mechanical, and may interface with the gesture interface 18 either physically or electromagnetically.

Wireless transceiver 20 may be operatively connected to the processor 14 and disposed within, mounted to, or integrated with the earpiece housing 12. Wireless transceiver 20 may be a Bluetooth transceiver, a WiMax transceiver, a Wi-Fi transceiver, or another type or class of wireless transceiver simultaneously receiving signals from electronic devices at substantial distances and meet one or more IEEE standards. Wireless transceiver 20 may be configured to receive signals from mobile devices such as smartphones, communications towers, satellites, entertainment systems, gaming systems, virtual reality/augmented reality devices, desktops, laptops, watches, or other types of electronic devices and communicate the signals to the processor 14. The processor 14 may use the data and/or information encoded in the signals during execution of one or more programs or applications and/or store the data and/or information in one or more memories. For example, signal encoding one or more connection frequencies received from a smartphone or a tablet may be received by the wireless transceiver 20 and communicated to the processor 14. The wireless transceiver 20 may utilize any number of communications, protocols, or standards. The processor 14 may subsequently instruct the wireless transceiver 20 to connect to the smartphone or tablet at the frequency encoded in the signal. Alternatively, the wireless transceiver 20 may transmit a signal encoding a frequency in which to connect to the wireless earpiece 10 may be received by various electronic devices. If an electronic device receives the signal and attempts to connect to the wireless earpiece 10, the wireless transceiver 20 may communicate the signal from the electronic device to the processor 14 so the electronic device may connect to the wireless earpiece 10.

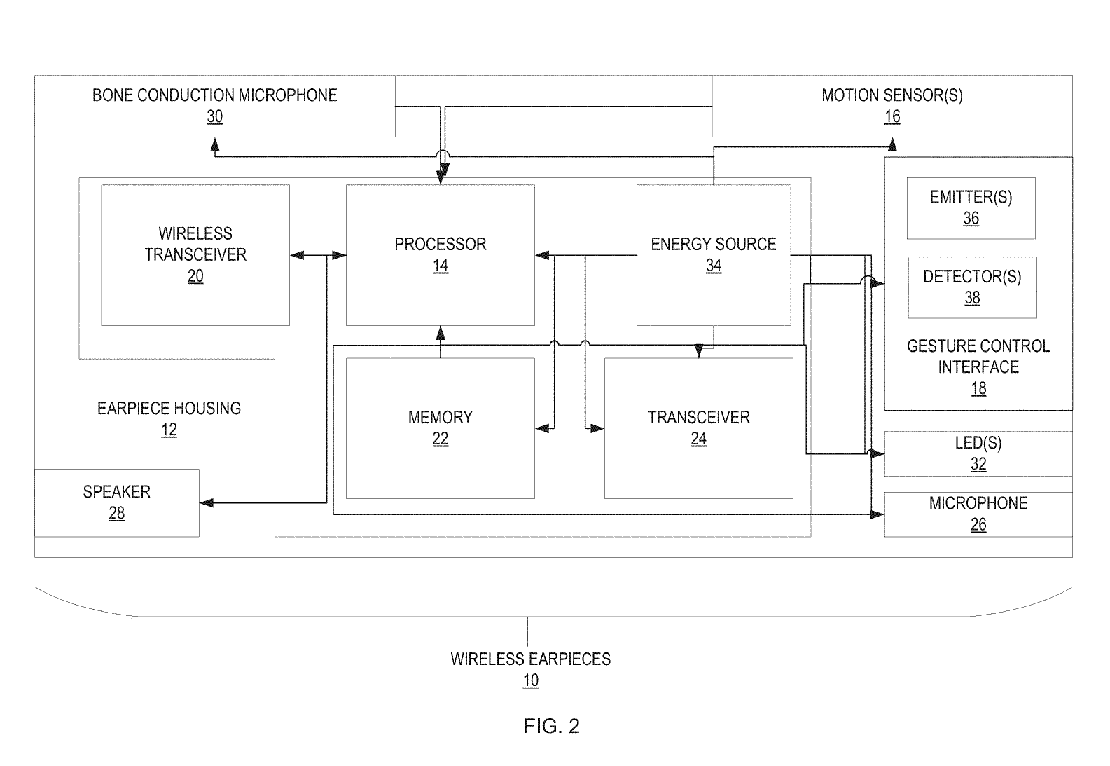

FIG. 2 illustrates a second embodiment of the wireless earpiece 10. In addition to the components listed above, the wireless earpiece 10 may include a memory 22, a transceiver 24, a microphone 26, a speaker 28, a bone conduction microphone 30, light emitting diodes (LEDs) 32, and an energy source 34. The components of the wireless earpiece 10 are interconnected by any number of busses, wires, traces, circuit boards, mother boards, ports, connectors, pins, or so forth as is known in the art.

The memory 22 may be operatively connected to the processor 14 and may be disposed within, mounted to, or integrated with the earpiece housing 12. The memory 22 may be any type of non-volatile memory, which may be static and/or dynamic, allowing data storage when the wireless earpiece 10 is not powered. In some embodiments additional volatile memories such as random-access memories may be incorporated into the memory 22 to allow for improved functionality. The memory 22 may be configured and/or programmed to store operating systems, kernels, applications, programs, instructions and/or data for either concurrent or future use and in some embodiments the memory 22 may be integrated with the processor 14 for improved functionality. The memory 22 may also store songs, podcasts, or other forms of media the user may listen to or engage with. The memory 22 may also store fitness and other types of related applications for the user to use.

The wireless transceiver 24 may be operatively connected to the processor 14 and disposed within, mounted to, or integrated with the earpiece housing 12. For example, the transceiver 24 may be a near field magnetic induction (NFMI) transceiver, a Bluetooth transceiver, a WiMax transceiver, a Wi-Fi transceiver, or another type or class of transceiver meeting one or more IEEE standards. In addition, more than one type of transceiver, such as a hybrid or multi-mode transceiver, may be in the wireless earpiece 10. The wireless transceiver 24 may be configured to transmit signals to or receive signals from another wireless earpiece if the user is wearing a set of wireless earpieces 50. The wireless transceiver 24 may also receive signals from mobile devices, communications towers, Wi-Fi hotspots, or other communication locations. For example, signals received by a user's mobile device 60 (e.g., 3G, 4G, 5G, PCS, LTE, etc.) encoding programs for use by the wireless earpiece 10 may be transmitted by the mobile device 60 to the transceiver 24. The programs encoded in the signals may subsequently be used by the processor 14 and/or stored in the memory 22.

Microphone 26 is operatively connected to the processor and may be mounted to or integrated with the earpiece housing 12. The microphone 26 may include components, such as analog-to-digital converters, amplifiers, attenuators, filters, and/or other components necessary for the microphone to convert a sound wave into an electrical signal. In one embodiment, the microphone 26 is an over-air microphone externally positioned to the body of the user when the wireless earpieces 10 are worn. The microphone 26 may be positioned on a section of the earpiece housing 12 facing away from the user's ear to receive a voice command or other audio input from the user or a third party. For example, the user may issue a voice command to the wireless earpiece 10 to access one or more pieces of media, such as a song stored in the memory 22 via the microphone 16. In addition, voice commands and audio input received by the microphone 16 may be stored in the memory 22 for future use by one or more applications or programs stored in the memory 22 the microphone 16 may also gather environmental data and information from the noises and sounds of the environment.

Speaker 28 may be operatively connected to the processor 14 and may be mounted to or integrated with the earpiece housing 12. The speaker 28 may be positioned in an area conducive for communicating sounds to the tympanic membrane of the user's ear. The speaker 28 may include components such as digital-to-analog converters, amplifiers, attenuators, filters, and/or other components necessary for the speaker 28 to convert an electrical signal into a sound wave. Communications from the speaker 28 may include a menu for selecting one or more songs, music, fitness programs, games or other media or fitness-related programs. The components of the speaker 28 may be further configured and/or programmed to generate three-dimensional stereo sound or to generate sounds at specific frequencies.

Bone conduction microphone 30 may be operatively connected to the processor 14 and positioned on the earpiece housing 12 to meet a temporal bone of the user when the wireless earpiece 10 is inserted into a user's ear canal. The bone conduction microphone 30 may be configured to communicate sounds and/or vibrations via the temporal bone for user's who have difficulty hearing. In addition, the bone conduction microphone 30 may be configured to help filter out sounds to differentiate between sounds originating from the user and sounds originating from a third party or another external location.

LEDs 32 may be operatively connected to the processor 14 and may be mounted to or integrated with the earpiece housing 12. The LEDs 32 may be semiconductor-based light sources and may include displays, touch sensors, and/or other interactive interface components. In addition, the LEDs 32 may be configured to provide information concerning the wireless earpiece 10. For example, the processor 14 may communicate a signal encoding information related to the current time, the energy level of the wireless earpiece 10, the status of another operation of the wireless earpiece 10, or another wireless earpiece program or function to the LEDs 32. If the signal concerns the energy level of the wireless earpiece 10, the LEDs 32 may decode the signal as a colored light. For example, a blue light may represent a full battery, a green light may represent a high level of battery life, a yellow light may represent an intermediate level of battery life, a red light may represent a limited amount of battery life, and a blinking red light may represent a critical level of battery life requiring immediate recharging. In addition, the battery life may be represented by the LEDs 32 as a percentage of battery life remaining or may be represented by an energy bar having one or more LEDs. For example, the number of illuminated LEDs may represent the amount of battery life remaining in the wireless earpiece 10. The LEDs 32 may be in any area on the wireless earpiece 10 suitable for viewing by the user or a third party and may also include as few as one diode which may be provided in combination with a light guide. In addition, the LEDs 32 need not have a minimum luminescence.

Energy source 34 is operatively connected to all the components within the wireless earpiece 10. The energy source 34 may provide enough power to operate the wireless earpiece 10 for a reasonable duration of time. The energy source 34 may be of any type suitable for powering the wireless earpiece 10. For example, the energy source 34 may represent a high density rechargeable battery (e.g., a lithium ion battery, etc.), solar cell, fuel cell, all trust capacitor, piezo electric generator, or so forth. However, the energy source 34 need not be present in the wireless earpiece 10. For example, the wireless earpieces 10 may be powered by a head, neck, arm, or waist mounted battery pack connected to the wireless earpieces 10 through a wire, cable, or other physical connection. Alternative battery-less power sources, such as sensors configured to receive energy from radio waves (all of which are operatively connected to one or more wireless earpieces) may be used to power the wireless earpiece 10 in lieu of an energy source 34.

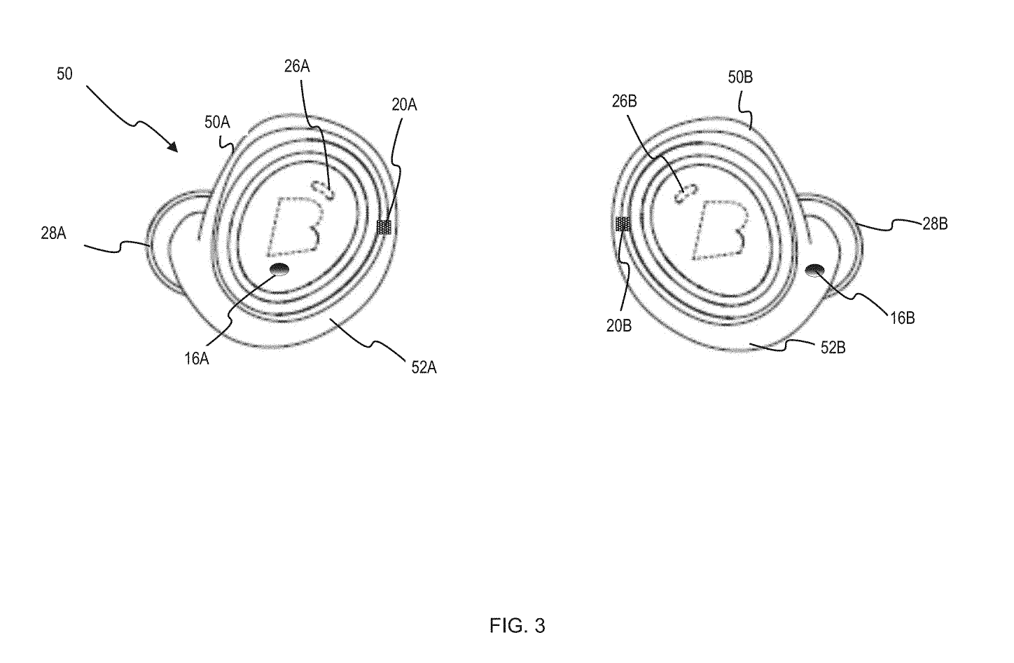

FIG. 3 illustrates a set of wireless earpieces 50 which includes a left wireless earpiece 50A and a right wireless earpiece 50B. The left wireless earpiece 50A has a left earpiece housing 52A. The right wireless earpiece 50B has a right earpiece housing 52B. The left wireless earpiece 50A and the right wireless earpiece 50B may be configured to fit on, at, or within a user's external auditory canal and may be configured to substantially minimize or eliminate external sound capable of reaching the user's tympanic membranes. The wireless earpiece housings 52A and 52B may be composed of any material with substantial deformation resistance and may also be configured to be soundproof or waterproof.

Motion sensors 16A and 16B are shown. Motion sensors 16A and 16B may be configured to sense head and neck motions such as the nodding or shaking of a user's head and may be configured to sense other physical motions or activities performed by the user. Wireless transceivers 20A and 20B are also shown. Each wireless transceiver may be configured to receive connection signals from other electronic devices or may transmit one or more connection signals received by other devices. The connection signals may encode one or more frequencies and/or wavelengths in which the left wireless earpiece 50A, the right wireless earpiece 50B, and/or one or more electronic devices may communicate with one another.

Microphones 26A and 26B are also shown. The microphones 26A and 26B may be located anywhere on the left wireless earpiece 50A and the right wireless earpiece 50B, respectively, and each microphones 26A, 26B may be positioned to receive one or more sounds or voice commands from the user, one or more sounds from a third party, or one or more ambient sounds from an object worn or carried by the user or the outside environment, whether natural or artificial.

A speaker 28A is shown on the left wireless earpiece 50A and a speaker 28B is shown on the right wireless earpiece 50B. Speakers 28A and 28B may be positioned proximate to the user's tympanic membranes and may be configured to communicate menu options for selecting a song, a fitness program, or another piece of media of interest to the user. Speakers 28A and 28B may also be configured to short out if any sounds exceed a certain decibel threshold, which may be preset or programmed by the user or a third party. In one embodiment, the speakers 28A, 28B may include several miniaturized or micro-speakers (e.g., tweeter, midrange, base, etc.). The speakers 28A, 28B may also perform noise cancellation based on signals detected by the microphones 26A, 26B.

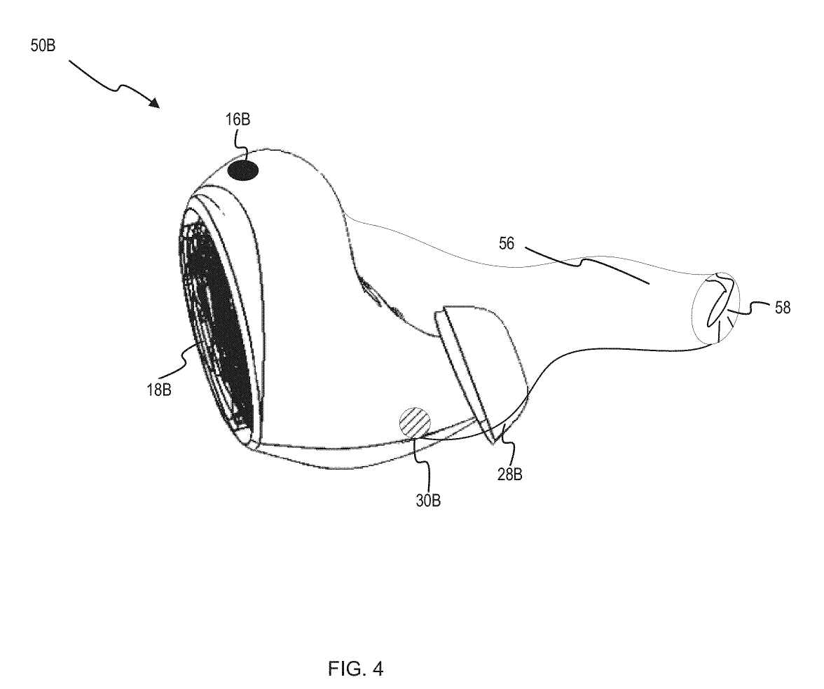

FIG. 4 illustrates a side view of the right wireless earpiece 50B and its relationship to a user's ear. The following description may also apply to wireless earpiece 10 of FIG. 1. The right wireless earpiece 50B may be configured to both minimize the amount of external sound reaching the user's external auditory canal 56 and to facilitate the transmission of sound from the speaker 28B to a user's tympanic membrane 58. The right wireless earpiece 50B may also be configured to be of any size necessary to comfortably fit completely or partially within the user's external auditory canal 56.

A motion sensor 16B, which may include an electronic accelerometer and/or gyroscope, positioned on the right wireless earpiece 50B to sense one or more head or neck motions. In addition, a bone conduction microphone 30B (also referred to as an ear-bone microphone) may be positioned near the temporal bone of the user's skull to produce sound vibrations for people who have difficulty hearing. The bone conduction microphone 30B may also sense sounds before the sounds reach the microphones 26B to differentiate between sounds from the user and ambient sounds.

The gesture interface 18B is a sensor measuring contact or motions performed proximate the gesture interface 18B. The gesture interface 18B may include one or more capacitive, infrared, optical, motion, touch, or other sensors. The gesture interface 18B may provide for gesture control by the user or a third party, such as by tapping or swiping across the gesture interface 18B, tapping or swiping across another portion of the right wireless earpiece 50B, providing a gesture not involving the touching of the gesture interface 18B or another part of the right wireless earpiece 50B, or through the use of an instrument configured to interact with the gesture interface 18B. The user may use the gesture interface 18B to pair or connect one or more electronic devices which may be in possession of the user or one or more third parties.

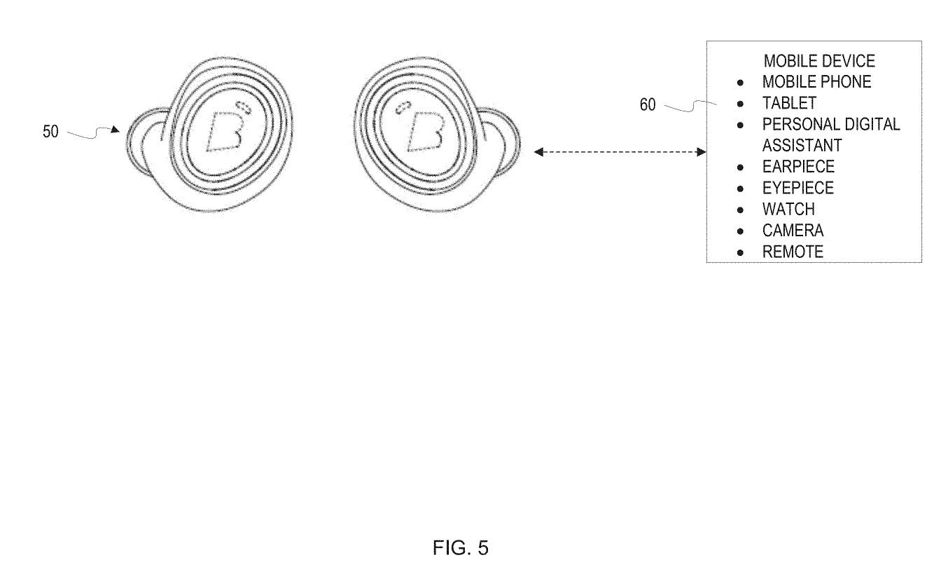

FIG. 5 illustrates a set of wireless earpieces 50 and their relationship to a mobile device 60. Wireless earpiece 10 of FIG. 1 may be a part of the set of wireless earpieces 50. The mobile device 60 may be a mobile phone, a tablet, a watch, a PDA, a remote, an eyepiece, an earpiece, a gaming device, a virtual/augmented reality system, a vehicle system, or any other portable/wireless device, system, equipment, or component. The user may use a software application, operating system, set of instructions, script, module, kernel, or other program on the mobile device 60 to connect with one or more of the wireless earpieces of the set of wireless earpieces 50. The connection request may be communicated to the set of wireless earpieces 50 via a transceiver of the mobile device 60. In connecting to the set of wireless earpieces 50, one or more icons or choices may appear on a screen of the mobile device 60 signifying the mobile device 60 has either received a connection request from one or more of the wireless earpieces of the set of wireless earpieces 50 or the mobile device 60 has received an acceptance of a connection in response to one or more signals encoding a communication frequency and/or wavelength transmitted by the mobile device 60. The connection may be established by touching an area on the screen where the icon is being displayed or using an interface on the mobile device 60 to establish the connection.

In addition, the user may use the mobile device 60 to upload songs, music, fitness programs, or other applications to the set of wireless earpieces 50 for immediate or later use. One or more of the wireless earpieces 50 may be worn while the user is uploading files to a wireless earpiece or one or more of the wireless earpieces 50 may be in the process of being charged for later use (e.g., docked within a smart case). Alternatively, the user may use the mobile device 60 to download songs, music, fitness programs, or other applications from the set of wireless earpieces 50. The mobile device 60 may connect to one or more of the wireless earpieces 50 to download content. For example, to expedite downloading, a program currently stored in more than one wireless earpiece of the set of wireless earpieces 50 may be downloaded in portions, where one wireless earpiece uploads one part of the program to the mobile device 60 and another wireless earpiece uploads another portion of the program to the mobile device 60. Depending on the capabilities of the mobile device 60, the foregoing tasks may be performed simultaneously, concurrently, or sequentially.

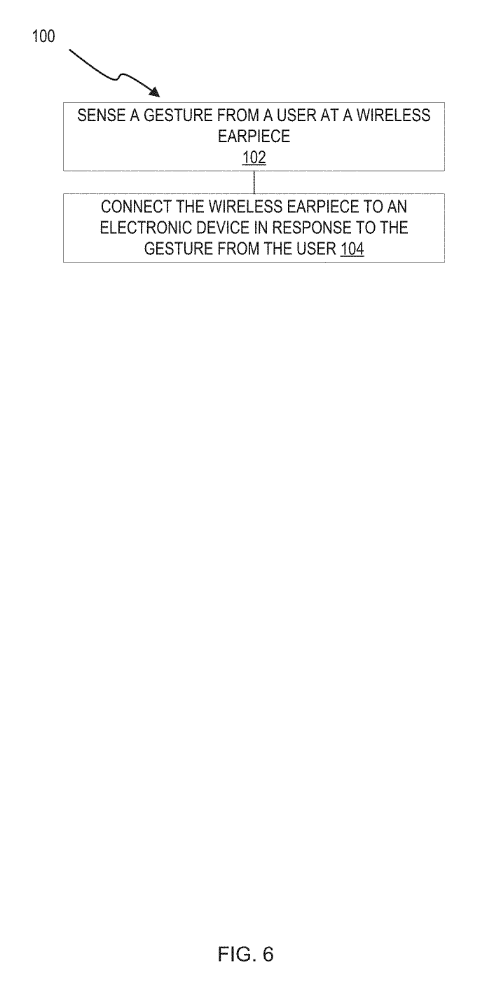

FIG. 6 illustrates a flowchart 100 of a method for connecting a wireless earpiece to an electronic device. First, in step 102, a user gesture is sensed by the wireless earpiece. The user gesture may be a nod sensed by a motion sensor of the earpiece, a tap or other type of physical gesture contacting the gesture interface or another part of the wireless earpiece, a voice command, or another type of physical gesture capable of being sensed by the wireless earpiece.

Second, in step 104, the wireless earpiece connects to another electronic device in response to the user gesture. The electronic device may be a mobile phone, a tablet, a laptop, a desktop computer, a Wi-Fi hotspot, or another type of electronic device capable of wirelessly connecting to another device, and the electronic device may connect automatically to the wireless earpiece or the wireless earpiece may connect automatically to the electronic device.

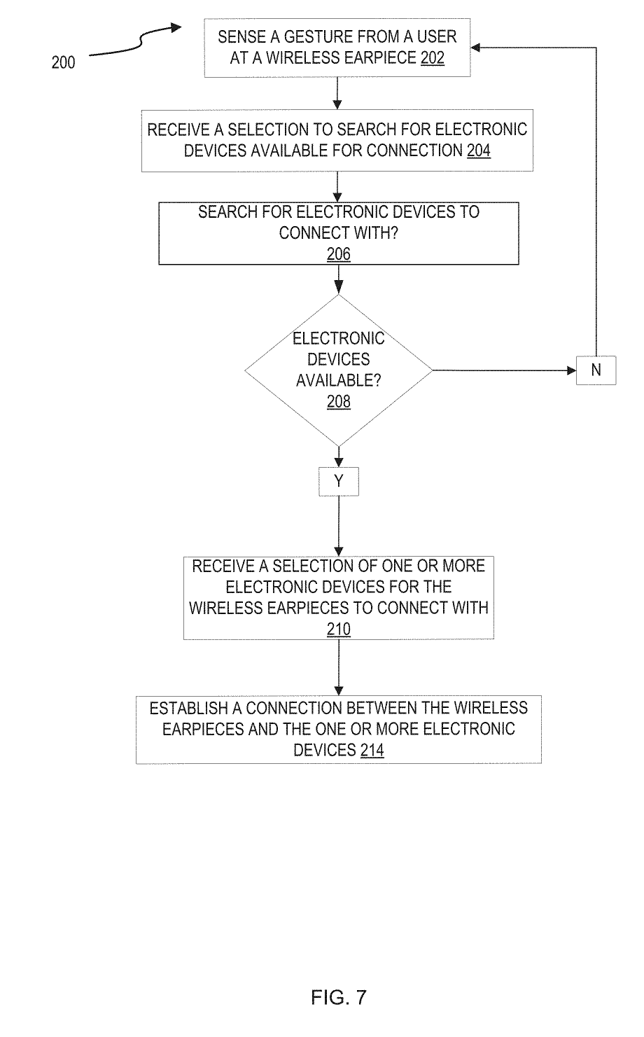

FIG. 7 illustrates a flowchart 200 of a second embodiment of a method of connecting a wireless earpiece to an electronic device. First, in step 202, a user gesture is sensed by the wireless earpiece. Detection of the user gesture may be performed utilizing any number of sensors of the wireless earpieces as previously outlined.

In step 204, the wireless earpieces receive a selection to search for electronic devices available for connection. In one embodiment, the wireless earpieces may prompt the user to provide a feedback or selection to establish a connection prior to receiving the selection of step 204. For example, the prompting may be communicated verbally via a speaker of the wireless earpiece or may be communicated via vibrations, LED displays, or other wireless earpiece functions discernible by the user as representing one or more functions of the earpiece. For example, if the wireless earpiece vibrates for two seconds, this vibration may represent the gesture was received and acknowledged by the wireless earpiece and is now awaiting additional input from the user.

Next in step 206, the wireless earpieces search for electronic devices to connect with. For example, during step 206, the wireless earpieces search for available or nearby electronic devices to connect with through signals, a connection or link. The search may be performed by enabling one or more transceivers, beacon detectors, sensors, or other components present in the wireless earpiece to receive connection signals from electronic devices. The transceivers may be configured to receive signals from outside electronic devices or may receive outside signals in response to one or more commands from the user. The connection signals may encode one or more frequencies and/or wavelengths in which a wireless earpiece may establish a connection to one or more electronic devices. In another embodiment, the wireless earpiece(s) may instruct a transceiver to transmit a signal encoding one or more frequencies and/or wavelength received by an electronic device. A connection between the electronic device and the wireless earpiece may be established automatically or may require additional input from an operator of the electronic device or the user.

Next, in step 208, the wireless earpieces determine whether electronic devices are available. If the search for electronic devices fails to return any results, then the process ends or returns to step 202.

If electronic devices are available in step 208, then in step 210 the wireless earpieces receive a selection of one or more electronic devices for the wireless earpieces to connect with. If, alternatively, the user does not select one of the electronic devices, the process ends or returns to step 202. The user may cancel the connection process at any time and is not required to select or connect to any available electronic devices. The search of step 206 may locate more than one electronic device available for connection. As a result, the wireless earpiece may prompt the user to select one or more electronic devices for the wireless earpieces to connect with. For example, the wireless earpieces may verbally communicate each choice via a speaker or communicate a menu in which the user may select from a list of choices. The menu may be connected through the wireless earpieces or a secondary electronic device already in communication with the wireless earpieces. The user may select a choice by issuing a verbal command representing one or more choices, issue a verbal command to go forward to the next choice, issue a verbal command to go back to the last choice, perform a voice gesture to move forward or back a specific number of choices, perform a gesture on the gesture interface or another portion of the wireless earpiece to go forward to the next choice, perform a gesture on the gesture interface or another portion of the wireless earpiece to go back to the last choice, perform a head motion to go forward or back, or any other types of input allowing a user to make a selection from a verbally, audibly, or audibly communicated list.

When the user selects one or more electronic devices to connect to in step 210, then in step 212 a connection is established between the wireless earpiece and the one or more electronic devices. The wireless earpieces may connect to the selected wireless earpieces simultaneously, concurrently, sequentially, or so forth. Further instructions or information may be provided in response to the establishment of one or more connections with an electronic device. If the user fails to select, the process ends or returns to step 202.

In another embodiment, the wireless earpieces may detect user input is directional in nature. The wireless earpieces may include and utilize one or more compasses, proximity sensors, beacon detectors, or other sensors to detect the position, orientation, location, availability, and other information associated with the wireless earpieces as well as the available electronic devices. For example, the directional user input may be utilized to select and connect to a specified electronic device. The directional user input may represent the user facing a direction, nodding or gesturing in a direction, head position and orientation, verbal description of the electronic device or associated name, combinations of user input, or so forth. In one example, the wireless earpieces may receive a selection to connect to a computing device in response to the user nodding her head in the direction of the computing device. As a result, the wireless earpieces may ignore potential connections with other electronic devices. In another example, the wireless earpieces may connect with a specified electronic device in response to the user moving or walking towards the electronic device. The motion may be utilized along with a pairing mode, prompt from the wireless earpiece, or so forth.

In another example, the user may orient his head in a direction of the specified electronic device before providing a verbal command or touch gesture and connect with the specified electronic device. In another example, the user may provide a verbal command associated with directions, such as “connect to the device ahead 10 feet and to my right 5 feet”, “connect to the nearest available electronic device”, “connect to the Bluetooth lightbulb overhead”, or other input.

The wireless earpieces may also utilize logic to combine with one or more electronic devices when available, in a specific order, based on location of the user, determined user activity, time of day, user utilizing the wireless earpieces (e.g., one of various potential users), or in a specified combination of electronic devices (e.g., available speakerphone, wireless speakers, etc.). The logic may be programmed by the user verbally or utilizing a user interface of an application for the wireless earpieces available through a connected electronic device.

The illustrative embodiments are not to be limited to the embodiments and examples described herein. The illustrative embodiments contemplate numerous variations in the type of ways in which the embodiments may be applied. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, the disclosure accomplishes at least all the intended objectives.

The previous detailed description is of a small number of embodiments for implementing the invention and is not intended to be limiting in scope. The following claims set forth several the embodiments disclosed with greater particularity.

What is claimed is:

1. A wireless earpiece comprising:
an earpiece housing;
a processor disposed within the earpiece housing;
a motion sensor operatively connected to the processor;
a gesture interface operatively connected to the processor; and
a wireless transceiver operatively connected to the processor;
wherein the wireless earpiece is configured to operably connect to an electronic device via the wireless transceiver in response to a user gesture sensed by the motion sensor or the gesture interface.

2. The wireless earpiece of claim 1, wherein the motion sensor is an electronic accelerometer.

3. The wireless earpiece of claim 1, wherein the gesture interface further comprises an emitter and a detector.

4. The wireless earpiece of claim 1, wherein the user gesture is a nod.

5. The wireless earpiece of claim 1, wherein the user gesture is a tap on the gesture interface.

6. The wireless earpiece of claim 3, wherein the user gesture is a motion sensed by the detector.

7. The wireless earpiece of claim 1, wherein the electronic device is one or more of a mobile phone, a tablet, and a laptop.

8. The wireless earpiece of claim 1, further comprising one or more speakers operatively connected to the processor, wherein an audio prompt is played to the user through the one or more speakers for the user to provide the user gesture to connect to the electronic device.

9. The wireless earpiece of claim 1 wherein the wireless earpiece is operable to connect to a plurality of electronic devices simultaneously.

10. A set of wireless earpieces, each wireless earpiece comprising:
an earpiece housing;
a processor disposed within each earpiece housing;
a motion sensor disposed within each earpiece housing and operatively connected to the processor;
a gesture interface disposed within each earpiece housing and operatively connected to the processor in the earpiece housing in which the gesture interface is mounted to; and
a wireless transceiver disposed within each earpiece housing and operatively connected to the processor in the earpiece housing in which the wireless transceiver is disposed within;
wherein at least one wireless earpiece of the set of wireless earpieces receives a selection by a first user gesture sensed by the motion sensor or the gesture interface to search for electronic devices available for connection; and
wherein at least one wireless earpiece of the set of wireless earpieces operably connects to one or more of the electronic devices via the wireless transceiver of the at least one wireless earpiece in response to a second user gesture sensed by the motion sensor of the at least one wireless earpiece or the gesture interface of the at least one earpiece.

11. The set of wireless earpieces of claim 10, wherein the set of wireless earpieces comprise a left wireless earpiece and a right wireless earpiece.

12. The set of wireless earpieces of claim 10, wherein the user gesture is a nod sensed by the motion sensor.

13. The set of wireless earpieces of claim 10, wherein the user gesture is a tap on the gesture interface.

14. A method of connecting a wireless earpiece to an electronic device comprising:
sensing a gesture from a user at the wireless earpiece;
prompting the user to connect to the electronic device;
connecting the wireless earpiece to the electronic device in response to the gesture from the user; and
sensing audio input including a verbal name or description associated with the electronic device for utilization with the gesture to connect to the electronic device.

15. The method of claim 14, wherein the gesture is sensed by a motion sensor operatively connected to the wireless earpiece.

16. The method of claim 15, where the gesture is a nod.

17. The method of claim 14, wherein the gesture is sensed by a gesture interface operatively connected to the earpiece.

18. The method of claim 17 wherein the gesture is a tap on the gesture interface.

19. The method of claim 14, wherein the electronic device is a mobile phone.

20. The method of claim 14, wherein the gesture indicates a direction associated with the electronic device.
